(19) United States
(12) Patent Application Publication
(10) Pub. No.: US 2025/0139188 A1
(43) Pub. Date: May 1, 2025

(54) SYSTEM AND METHOD FOR PROBLEM INFERENCE BASED ON MULTI-MODAL GENERATIVE ARTIFICIAL INTELLIGENCE

(71) Applicant: ELECTRONICS AND TELECOMMUNICATIONS RESEARCH INSTITUTE, Daejeon (KR)

(72) Inventors: Jeong Heo, Daejeon (KR); Oh Woog Kwon, Daejeon (KR); Jihee Ryu, Daejeon (KR); Young-Ae Seo, Daejeon (KR); Jin SEONG, Daejeon (KR); Jong Hun Shin, Daejeon (KR); Ki Young Lee, Daejeon (KR); Yo Han Lee, Daejeon (KR); Soojong Lim, Daejeon (KR)

(21) Appl. No.: 18/889,622

(22) Filed: Sep. 19, 2024

(30) Foreign Application Priority Data
Oct. 26, 2023 (KR) 10-2023-0144477

(51) Int. Cl. G06F 17/11; G06F 40/205; G06F 40/40; G06V 10/86

(52) U.S. Cl. CPC G06F 17/11; G06F 40/205; G06F 40/40; G06V 10/86

(57) ABSTRACT

A method for problem inference based on multi-modal generative artificial intelligence includes receiving question information including an image and text, generating formal languages by parsing the image and text of the question information, respectively, based on a pre-constructed problem solving template, generating text-based intermediate inference information for the question information by inputting the generated formal language to a formal language inference unit, generating image-based inference information by inputting the text-based intermediate inference information, the text included in the question information (hereinafter referred to as “text question information”), and the image included in the question information (hereinafter referred to as “image question information”) to a multi-modal image generation model, and generating text-based inference information by inputting the text-based intermediate inference information, the image-based inference information, and the text question information to a multi-modal text generation model.

### CROSS-REFERENCE TO RELATED APPLICATION

This application claims priority to Korean Patent Application No. 10-2023-0144477, filed on Oct. 26, 2023, the disclosure of which is hereby incorporated by reference herein in its entirety.

### BACKGROUND

### 1. Technical Field

The present disclosure relates to a system and method for problem inference based on multi-modal generative artificial intelligence (AI).

### 2. Description of Related Art

With the development of the existing artificial intelligence (AI) technology and deep learning, the image processing and natural language processing fields are rapidly advanced. An AI technology for a single modality (e.g., only an image or text) achieves technical maturity in a specific field, but essentially requires the ability to recognize and effectively comprehensively infer information on various modalities (e.g., a sense of sight, a sense of hearing, and feeling) in order to develop an AI technology that comprehensively thinks and judges similar to humans.

In order to achieve such an object, multi-modal AI research is being expanded. A technology for performing comprehensive inference by receiving various types of modality information (e.g., an image and text) as an input is being developed. There are various types of tasks for evaluating and improving the maturity of such a technology. As a representative example, an AI system that performs question answering (Q&A) based on sight information, solves a mathematical problem using figures and charts, or performs mathematical inference is being developed. This is one of multi-modal AI fields that require the high-dimensional inference ability.

The development of the AI technology achieves remarkable results from an aspect of technical maturity. However, one of major disadvantages of the deep learning technology is that it is difficult to interpret and explain results. This may act as a great limit in an AI inference task that handles multi-modal information. Accordingly, there is a need for a technology for improving the interpretation and explanation of results in the multi-modal AI field.

### SUMMARY

Various embodiments are directed to providing a system and method for problem inference based on multi-modal generative AI, which can provide an interpretable and explainable solving process by combining an image and text through a multi-modal technology.

Various embodiments are directed to providing a system and method for problem inference based on multi-modal generative AI, which can explain a solving process stage by stage by using a multi-modal generative AI technology in order to solve a problem including heterogeneous modalities and generate the solving process in an interpretable and explainable form by combining an image and text.

However, objects of the present disclosure to be achieved are not limited to the aforementioned object, and other objects may be present.

A method for problem inference based on multi-modal generative AI according to a first aspect of the present disclosure includes receiving question information including an image and text, generating formal languages by parsing the image and text of the question information, respectively, based on a pre-constructed problem solving template, generating text-based intermediate inference information for the question information by inputting the generated formal language to a formal language inference unit, generating image-based inference information by inputting the text-based intermediate inference information, the text included in the question information (hereinafter referred to as “text question information”), and the image included in the question information (hereinafter referred to as “image question information”) to a multi-modal image generation model, and generating text-based inference information by inputting the text-based intermediate inference information, the image-based inference information, and the text question information to a multi-modal text generation model.

Furthermore, a method for problem inference based on multi-modal generative AI according to a second aspect of the present disclosure includes receiving question information including an image and text, generating formal languages by parsing the image and text of the question information, respectively, based on a pre-constructed problem solving template, generating text-based intermediate inference information for the question information by inputting the generated formal language to a formal language inference unit, generating text-based inference information by inputting the text-based intermediate inference information, the text included in the question information (hereinafter referred to as “text question information”), and the image included in the question information (hereinafter referred to as “image question information”) to a multi-modal text generation model, and generating image-based inference information by inputting the text-based inference information, the text-based intermediate inference information, and the image question information to a multi-modal image generation model.

Furthermore, a system for problem inference based on multi-modal generative AI according to a third aspect of the present disclosure includes a communication module configured to receive question information including an image and text, memory configured to store a pre-constructed problem solving template, a pre-trained formal language inference unit, a multi-modal image generation model, and a multi-modal text generation model and to store a program for generating text- or image-based inference information, and a processor configured to generate formal languages by parsing the image and text of the question information, respectively based on the problem solving template, to generate text-based intermediate inference information for the question information by inputting the generated formal language to the formal language inference unit, to generate the image-based inference information by inputting the text-based intermediate inference information and the text included in the question information (hereinafter referred to as “text question information”) and the image included in the question information (hereinafter referred to as “image question information”) to the multi-modal image generation model, and to generate the text-based inference information by inputting the text-based intermediate inference information, the image-based inference information, and the text question information to the multi-modal text generation model, by executing the program stored in the memory.

A computer program according to another aspect of the present disclosure executes the method for problem inference based on multi-modal generative AI in combination with a computer, that is, hardware, and is stored in a computer-readable recording medium.

Other details of the present disclosure are included in the detailed description and the drawings.

According to the embodiment of the present disclosure, a solving process for a question is presented along with chain-of-thought (CoT) of text and chain-of-images (CoI) of an image with respect to the question including the image and text by using multi-modal generative AI. Accordingly, the solving process can be interpreted, and the results of the AI can be explained. In particular, there are advantages in that the limit of AI for the existing single modality can be overcome by presenting methodology for image/text-based multi-modal AI inference, which may be applied to geometric mathematical problems and visual Q&A problems for diagrams or images, and methodology for an application in a tutor system and interpretability and explainability, that is, great disadvantages in AI, can be provided by also presenting a solving process for text and an image.

Furthermore, a method capable of presenting an inference process capable of being explainable and interpretable can be developed by providing a multi-modal-based AI inference technology in which an image (i.e., visual information) and text (i.e., language information) are comprehensively considered, like humans who have a multi-modal inference ability to comprehensively infer information that is recognized through various cognition processes. The method can be used in various educational/industrial fields in which an image and text need to be comprehensively considered. In particular, for example, if the method is applied to an automatic tutor system in an education field in which both an image and text are presented, it is expected that industrial/educational ripple effects will be great. Furthermore, it is expected that the method may contribute to the development of artificial general intelligence (AGI) as a base technology for multi-modal AI.

Effects of the present disclosure which may be obtained in the present disclosure are not limited to the aforementioned effects, and other effects not described above may be evidently understood by a person having ordinary knowledge in the art to which the present disclosure pertains from the following description.

### BRIEF DESCRIPTION OF THE DRAWINGS

FIG. 1 is a diagram illustrating an example in which a system and method for problem inference based on multi-modal generative AI according to an embodiment of the present disclosure have been applied.

FIG. 2 is a block diagram of a system for problem inference based on multi-modal generative AI according to an embodiment of the present disclosure.

FIG. 3 is a flowchart of a method for problem inference based on multi-modal generative AI according to a first embodiment of the present disclosure.

FIG. 4 is a diagram illustrating an example of a method for problem inference based on multi-modal generative AI according to an embodiment of the present disclosure.

FIGS. 5A and 5B are diagrams for describing a process of parsing question information in an embodiment of the present disclosure.

FIG. 6A is a diagram illustrating an example of a process of generating inference information in a multi-modal image generation model according to an embodiment of the present disclosure.

FIG. 6B is a diagram illustrating an example of a process of generating inference information in a multi-modal text generation model in an embodiment of the present disclosure.

FIG. 7 is a flowchart of a method for problem inference based on multi-modal generative AI according to a second embodiment of the present disclosure.

### DETAILED DESCRIPTION

Advantages and characteristics of the present disclosure and a method for achieving the advantages and characteristics will become apparent from the embodiments described in detail later in conjunction with the accompanying drawings. However, the present disclosure is not limited to embodiments disclosed hereinafter, but may be implemented in various different forms. The embodiments are merely provided to complete the present disclosure and to fully notify a person having ordinary knowledge in the art to which the present disclosure pertains of the category of the present disclosure. The present disclosure is merely defined by the claims.

Terms used in this specification are used to describe embodiments and are not intended to limit the present disclosure. In this specification, an expression of the singular number includes an expression of the plural number unless clearly defined otherwise in the context. The term “comprises” and/or “comprising” used in this specification does not exclude the presence or addition of one or more other elements in addition to a mentioned element. Throughout the specification, the same reference numerals denote the same elements. “And/or” includes each of mentioned elements and all combinations of one or more of mentioned elements. Although the terms “first”, “second”, etc. are used to describe various components, these elements are not limited by these terms. These terms are merely used to distinguish between one element and another element. Accordingly, a first element mentioned hereinafter may be a second element within the technical spirit of the present disclosure.

All terms (including technical and scientific terms) used in this specification, unless defined otherwise, will be used as meanings which may be understood in common by a person having ordinary knowledge in the art to which the present disclosure pertains. Furthermore, terms defined in commonly used dictionaries are not construed as being ideal or excessively formal unless specially defined otherwise.

Embodiments of the present disclosure relate to a system and method for problem inference based on multi-modal generative AI.

To infer a problem including an image (e.g., a figure or a diagram) and text is the core of AI using a human's complex cognition ability to present results by analyzing and inferring an image that is seen through a sense of sight and a speech that is heard through a sense of hearing.

The past AI technology has been researched by being focused on the inference of single intelligence in which an image and text are separately processed. However, as research of complex intelligence recently becomes active, research of an AI technology based on multi-modal is carried out. The multi-modal AI leads to various researches, such as the captioning of video/image, image-text retrieval, and text-to-image generation. However, the corresponding researches may have a problem with the reliability of results because an unclear portion is present in a result generation process and an interpretation process.

Recently, in the natural language processing field, a large language model (LLM) technology has been developed and in the spotlight. Furthermore, a prompt engineering technology for designing a specific prompt for obtaining desired results by using the LLM is developed. A problem in that the interpretation and explanation of results, that is, the greatest disadvantage in the deep learning technology of a conventional technology, is difficult can be solved through the LLM technology and the prompt engineering technology.

Furthermore, a chain-of-thought (CoT) technology is a technology for generating a flow of thoughts for results by using the LLM, and enables results presented by the LLM to be interpreted and explained. Furthermore, a self-consistency technology is a technology that maintains consistency by integrating various types of voting for results and increases the reliability of the results. Performance of the CoT can be improved through the self-consistency technology.

If multi-modal generative AI and an inference technology based on the CoT are grafted, the utilization of a multi-modal AI-based inference system using AI can be maximized because a solving and interpretation process for a problem including heterogeneous modalities can be automatically presented. Accordingly, an embodiment of the present disclosure is to propose a system and method for problem inference based on multi-modal generative AI, which can explain and interpret a multi-modal (i.e., an image and text) problem and present a solving process by using multi-modal generative AI and a prompt engineering technology, such as the CoT. In particular, an embodiment of the present disclosure proposes a method of presenting chain-of-images (CoI) that enables the final result image to be interpreted by presenting an intermediate process in the generation of a result image, such as CoT research, by using the LLM.

Furthermore, an embodiment of the present disclosure proposes the presentation of both interpretability and explainability that are described as a disadvantage of AI by presenting a process of complexly inferring various tasks including both images and text by combining the CoT and the CoI. The corresponding technology provides an essential technology for inferring a mathematical problem including an image, such as a figure or a diagram, and text of math word problems (MWP). Accordingly, a mathematics education and tutor system can be developed through such a technology.

Furthermore, an embodiment of the present disclosure may propose explainable results in various tasks that need to process multi-modal information like a visual question answering (Q&A) task that presents a question along with various images.

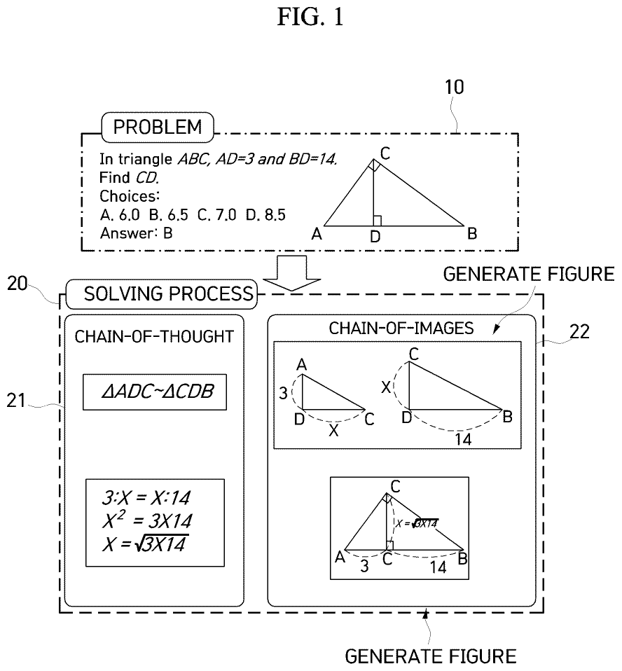

FIG. 1 is a diagram illustrating an example in which a system and method for problem inference based on multi-modal generative AI according to an embodiment of the present disclosure have been applied.

An embodiment of the present disclosure may propose an interpretable and explainable solving process by using a multi-modal generative AI technology with respect to question information 10 including both an image and text, as illustrated in FIG. 1. In this case, in an embodiment of the present disclosure, a mathematical problem is basically described as an example, but the present disclosure is not essentially limited thereto and may be applied to a general portion of multi-modal AI inference including an image and text.

As in the example of FIG. 1, when the question information 10 described as a figure image and text is presented, in order to accurately solve such a problem, the text and image need to be comprehensively analyzed and inferred because the question information 10 including the image and text has a complex modality. In this case, the existing generative AI has a limit in that it basically presents only an answer and does not provide a process and interpretation for results.

In a solving process 20, both a solving process 21 that is inferred from the text and a solving process 22 that is inferred from the image are presented.

First, the CoT technology may be used in the solving process 21 for the text problem. The CoT is a technology based on the LLM and prompt engineering, and is a technology that presents a flow of thoughts including a process of finding an answer. The CoT enables the interpretation of results by explicitly presenting a solving process for an answer, unlike the existing case in which an inference process for an answer cannot be interpreted and explained because only the answer is provided.

Furthermore, an embodiment of the present disclosure newly proposes a CoI concept by placing emphasis on the solving process 22 of inferring an answer from the image. The CoI means that an answer is inferred and a process thereof is presented as an image based on a figure image of a problem by using a multi-modal image generation model. In an intermediate process of the CoT, when a button called “Generate a figure” is clicked on, a multi-modal image generation model may generate and present a solving process image based on a solving process that has been described as text. This enables a solving process for a problem to be more intuitively understood.

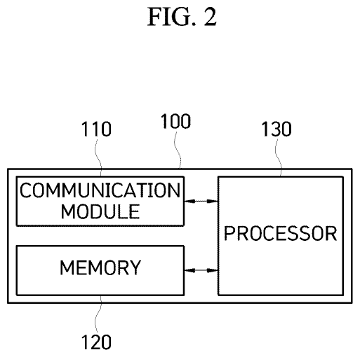

Hereinafter, a system 100 for problem inference based on multi-modal generative AI according to an embodiment of the present disclosure is explained with reference to FIG. 2.

FIG. 2 is a block diagram of the system 100 for problem inference based on multi-modal generative AI according to an embodiment of the present disclosure.

The system 100 for problem inference based on multi-modal generative AI according to an embodiment of the present disclosure includes a communication module 110, memory 120, and a processor 130.

The communication unit 110 receives question information including an image and text. The communication unit 110 may include both a wired communication module and a wireless communication module. The wired communication module may be implemented as a power line communication device, a telephone line communication device, cable home (MoCA), Ethernet, IEEE1294, an integrated wired home network, or an RS-485 controller. Furthermore, the wireless communication module may be constructed as a module for implementing a function, such as a wireless LAN (WLAN), Bluetooth, an HDR WPAN, UWB, ZigBee, impulse radio, a 60GHz WPAN, binary-CDMA, a wireless USB technology, a wireless HDMI technology, 5^{th} generation (5G) communication, long term evolution-advanced (LTE-A), long term evolution (LTE), or wireless fidelity (Wi-Fi).

The memory 120 stores a pre-constructed problem solving template, a pre-trained formal language inference unit, a multi-modal image generation model, and a multi-modal text generation model, and stores a program for generating text or image-based inference information. In this case, the memory 120 commonly refers to a nonvolatile storage device that retains information stored therein although power is not supplied to the nonvolatile storage device and a volatile storage device. For example, the memory 120 may include NAND flash memory such as a compact flash (CF) card, a secure digital (SD) card, a memory stick, a solid-state drive (SSD), and a micro SD card, a magnetic computer memory device such as a hard disk drive (HDD), and an optical disc drive such as CD-ROM and DVD-ROM.

The processor 130 may control at least another component (e.g., a hardware or software component) of the system 100 for problem inference based on multi-modal generative AI by executing software, such as a program, and may perform various data processing or operations.

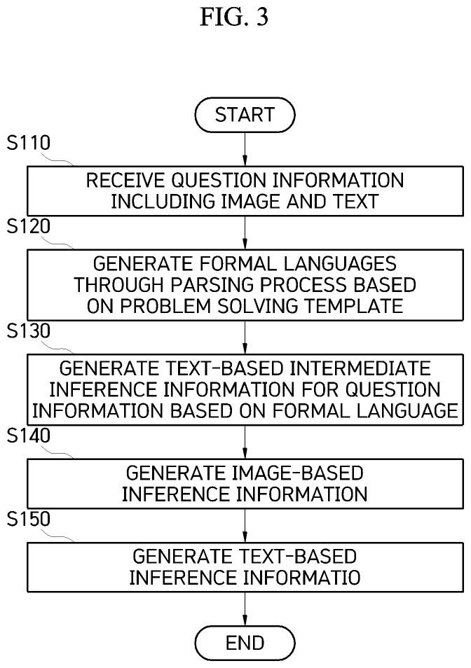

Hereinafter, a method that is performed by the system 100 for problem inference based on multi-modal generative AI according to an embodiment of the present disclosure is described with reference to FIGS. 3 to 7.

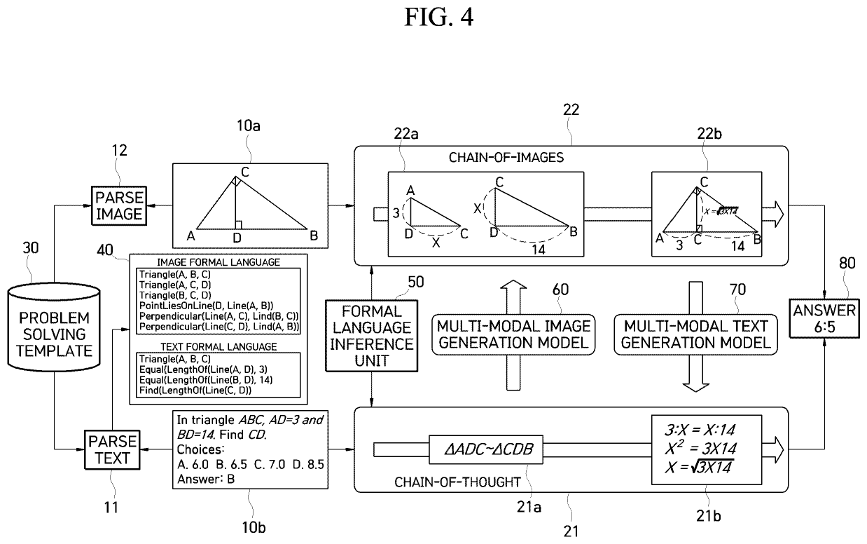

FIG. 3 is a flowchart of a method for problem inference based on multi-modal generative AI according to a first embodiment of the present disclosure. FIG. 4 is a diagram illustrating an example of a method for problem inference based on multi-modal generative AI according to an embodiment of the present disclosure.

In the method for problem inference based on multi-modal generative AI according to the first embodiment of the present disclosure, first, question information including an image and text is received (S110). In this case, the question information consists of image question information 10a and text question information 10b.

Next, formal languages 40 are generated (S120) by parsing (12 and 11) the image question information 10a and the text question information 10b, respectively, based on a pre-constructed problem solving template 30. In this case, the formal language 40 defines a structure and format of the question information, and may be used in an inference and solving process. The formal language 40 needs to be described in a format that has been defined in the problem solving template 30. The parsing 12 of the image question information 10a and the parsing 11 of the text question information 10b are each a process for extracting and understanding meaningful information in each modality. A method based on a rule or a method based on deep learning may be used in the parsing.

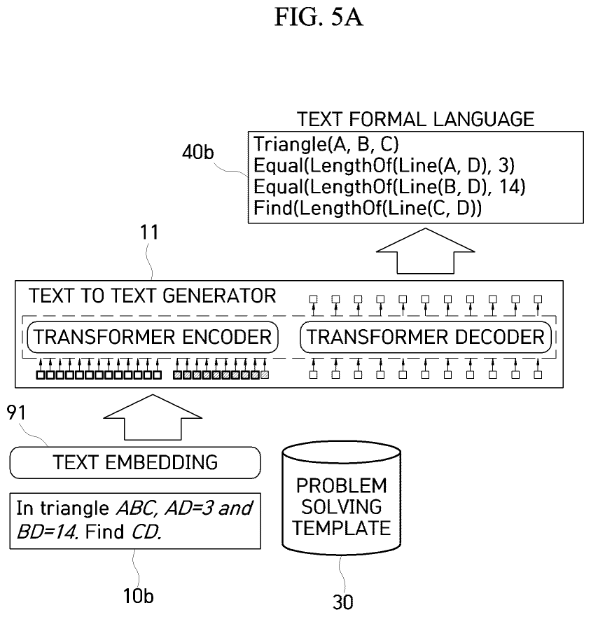

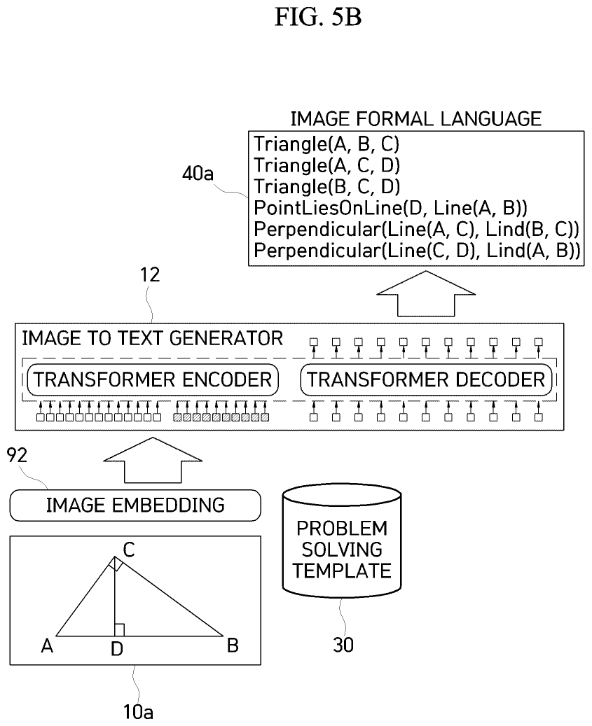

FIGS. 5A and 5B are diagrams for describing a process of parsing question information in an embodiment of the present disclosure.

As an embodiment, referring to FIG. 5A, in the parsing of the text question information 10b, a text embedding vector is generated by performing text embedding 91 on the text question information. Thereafter, the text embedding vector is input to an encoder that constitutes a text-to-text generative model 11. Furthermore, the results of search for the formal language are output from the problem-solving template 30 based on the input text embedding vector. A text format language 40b may be generated by integrating the results of the output with the text embedding vector and inputting the results of the integration to a decoder that constitutes the text-to-text generative model 11.

Methodology using a knowledge-augmented language model (LM) is used in this process. This enables the decoder to generate the formal language defined in the problem solving template 30 by enhancing information on a text input by considering the problem solving template 30 as knowledge.

As an embodiment, referring to FIG. 5B, in the parsing of the image question information 10a, an image embedding vector is generated by performing image embedding 92 on the image question information 10a. Thereafter, in the same way as the text, the results of search for the formal language are output from the problem solving template 30 by inputting the image embedding vector to an encoder that constitutes an image-to-text generative model (or generator) 12. An image format language 40a may be generated by integrating the results of the output with the image embedding vector and inputting the results of the integration to a decoder that constitutes the image-to-text generative model 12.

In this case, each of the text-to-text generative model 11 and the image-to-text generative model 12 is a fine-tuned model that is specially adjusted to be suitable for a given task by using the pre-constructed problem solving template 30 and training data.

Referring back to FIGS. 3 and 4, text-based intermediate inference information for the question information is generated (S130) by inputting, to a formal language inference unit 50, the formal languages 40 that have been generated through the text parsing 11 and the image parsing 12. In the case of the example in FIG. 4, mathematical inference “a perpendicular line is drawn at a point C at which a right angle of a right triangle is present. When the foot of the perpendicular line is called D, a right triangle ADC and a right triangle CDB are similar.” in the generated formal language 40 is performed. Intermediate inference information ΔADC ˜ΔCDB 21a may be generated through such inference.

Thereafter, image-based inference information is generated (S140) by inputting the text-based intermediate inference information, the text question information, and the image question information to a multi-modal image generation model.

Referring to the example of FIG. 4, images 22a of the right triangles ΔADC and ΔCDB, that is, image-based inference information, are generated through a multi-modal image generation model 60 by receiving the generated intermediate inference information ΔADC ˜ΔCDB 21a, the text question information 10b, and the image question information 10a.

Thereafter, text-based inference information is generated by inputting the text-based intermediate inference information, the image-based inference information, and the text question information to a multi-modal text generation model (S150).

Referring to the example of FIG. 4, a multi-modal text generation model 70 may generate text-based inference information ΔADC ˜ΔCDB (21b) by receiving the right triangle ΔADC, that is, the image-based inference information 22a, and the text-based intermediate inference information ΔADC ˜ΔCDB 21a along with the text question information 10b.

As described above, an embodiment of the present disclosure can improve the accuracy of results and the reliability of a solving process by mutually supplementing the results of CoT and CoI through the multi-modal image generation model 60 and the multi-modal text generation model 70.

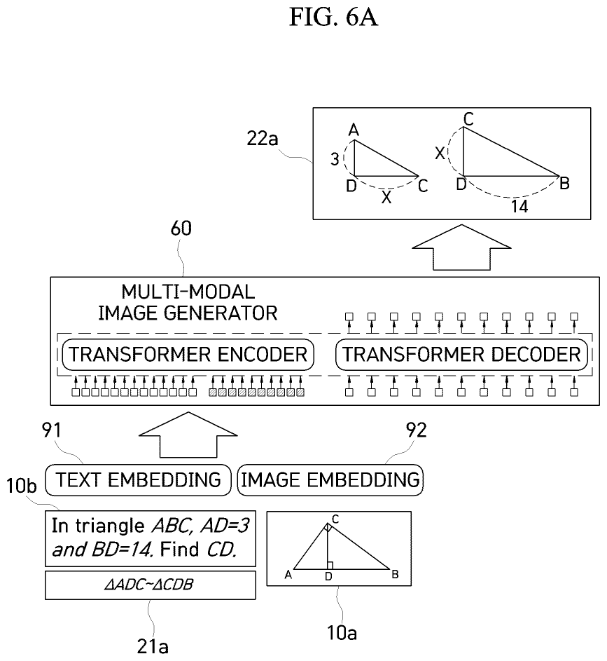

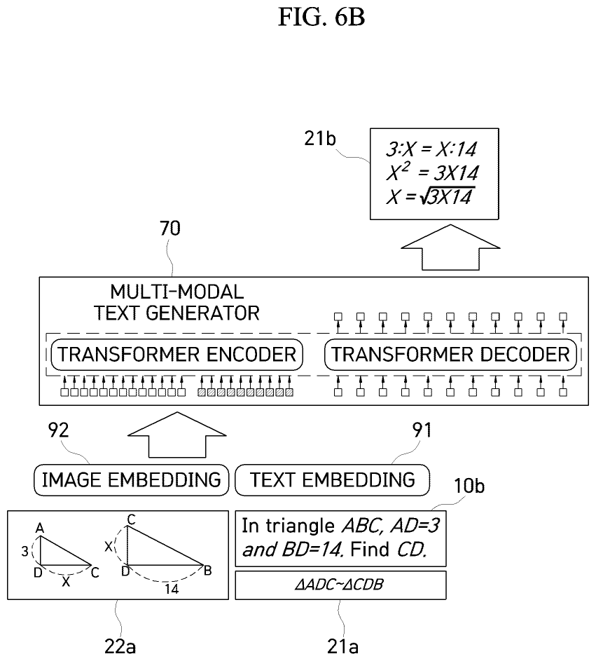

FIG. 6A is a diagram illustrating an example of a process of generating inference information in the multi-modal image generation model 60 according to an embodiment of the present disclosure.

As an embodiment, the multi-modal image generation model receives the text-based intermediate inference information 21a (i.e., the intermediate results of CoT), the text question information 10b, and the image question information 10a.

Thereafter, the multi-modal image generation model performs the text embedding 91 on the text-based intermediate inference information 21a and the text question information 10b because the text-based intermediate inference information 21a and the text question information 10b are text, and performs the image embedding 92 on the image question information 10a.

Thereafter, the results of the text embedding and the image embedding are input to the encoder that constitutes the multi-modal image generation model 60. The image-based inference information 22a may be generated by inputting the results of the output from the encoder to the decoder.

FIG. 6B is a diagram illustrating an example of a process of generating inference information in the multi-modal text generation model 70 in an embodiment of the present disclosure.

As an embodiment, in an opposite case, the multi-modal text generation model receives the text-based intermediate inference information 21a, the image-based inference information 22a, and the text question information 10b.

Thereafter, the multi-modal text generation model performs the text embedding on the text-based intermediate inference information 21a and the text question information 10b because the text-based intermediate inference information 21a and the text question information 10b are text, and performs the image embedding on the image-based inference information 22a.

Thereafter, the results of the text embedding and the image embedding are input to the encoder that constitutes the multi-modal text generation model 70. The text-based inference information 21b, that is, next results of CoT, may be generated by inputting the results of the output from the encoder to the decoder.

As described above, in an embodiment of the present disclosure, the multi-modal image generation model and the multi-modal text generation model may present a solving process for a problem including both an image and text by mutually complementarily generating CoT and CoI.

Thereafter, in FIG. 4, the final answer 6.5 (80) is generated through the CoT and CoI processes and selected in a choice.

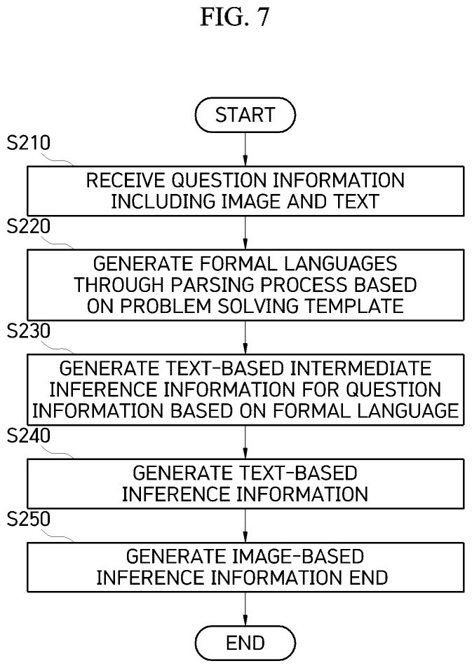

FIG. 7 is a flowchart of a method for problem inference based on multi-modal generative AI according to a second embodiment of the present disclosure. Most of core technical characteristics of the first and second embodiments of the present disclosure are identically shared, but a sequence in which the text-based inference information and the image-based inference information are generated in the second embodiment is different from that in the first embodiment.

In the method for problem inference based on multi-modal generative AI according to the second embodiment of the present disclosure, first, question information including an image and text is received (S210).

Next, formal languages are generated (S220) by parsing image question information and text question information, respectively, based on a pre-constructed problem solving template.

Next, text-based intermediate inference information for the question information is generated (S230) by inputting, to the formal language inference unit, the formal languages that have been generated through the text parsing and the image parsing.

Next, text-based inference information is generated (S240) by inputting the text-based intermediate inference information, the text question information, and the image question information to a multi-modal text generation model.

Next, image-based inference information is generated (S250) by inputting the text-based intermediate inference information, the text-based inference information, and the image question information to a multi-modal image generation model.

In the aforementioned description, each of steps S110 to S250 may be further divided into additional steps or the steps may be combined into smaller steps depending on an implementation example of the present disclosure. Furthermore, some of the steps may be omitted, if necessary, and the sequence of the steps may be changed. Furthermore, the contents of FIGS. 1 and 2 and the contents of FIGS. 3 to 7 may be mutually applied.

The aforementioned embodiment of the present disclosure may be implemented in the form of a program (or application) in order to be executed by being combined with a computer, that is, hardware, and may be stored in a medium.

The aforementioned program may include a code coded in a computer language, such as C, C++, JAVA, Ruby, or a machine language which is readable by a processor (CPU) of a computer through a device interface of the computer in order for the computer to read the program and execute the methods implemented as the program. Such a code may include a functional code related to a function, etc. that defines functions necessary to execute the methods, and may include an execution procedure-related control code necessary for the processor of the computer to execute the functions according to a given procedure. Furthermore, such a code may further include a memory reference-related code indicating at which location (address number) of the memory inside or outside the computer additional information or media necessary for the processor of the computer to execute the functions needs to be referred. Furthermore, if the processor of the computer requires communication with any other remote computer or server in order to execute the functions, the code may further include a communication-related code indicating how the processor communicates with the any other remote computer or server by using a communication module of the computer and which information or media needs to be transmitted and received upon communication.

The stored medium means a medium, which semi-permanently stores data and is readable by a device, not a medium storing data for a short moment like a register, cache, or a memory. Specifically, examples of the stored medium include a ROM, a RAM, a CD-ROM, a magnetic tape, a floppy disk, optical data storage, etc., but the present disclosure is not limited thereto. That is, the program may be stored in various recording media in various servers which may be accessed by a computer or various recording media in a computer of a user. Furthermore, the medium may be distributed to computer systems connected over a network, and a code readable by a computer in a distributed way may be stored in the medium.

The description of the present disclosure is illustrative, and a person having ordinary knowledge in the art to which the present disclosure pertains will understand that the present disclosure may be easily modified in other detailed forms without changing the technical spirit or essential characteristic of the present disclosure. Accordingly, it should be construed that the aforementioned embodiments are only illustrative in all aspects, and are not limitative. For example, elements described in the singular form may be carried out in a distributed form. Likewise, elements described in a distributed form may also be carried out in a combined form.

The scope of the present disclosure is defined by the appended claims rather than by the detailed description, and all changes or modifications derived from the meanings and scope of the claims and equivalents thereto should be interpreted as being included in the scope of the present disclosure.

### Description of Reference Numerals

100: system for problem inference based on multi-modal generative AI
110: communication module
120: memory
130: processor

What is claimed is:

1. A method for problem inference based on multi-modal generative artificial intelligence, the method being performed by a computer and comprising:
receiving question information comprising an image and text;
generating formal languages by parsing the image and text of the question information, respectively, based on a pre-constructed problem solving template;
generating text-based intermediate inference information for the question information by inputting the generated formal language to a formal language inference unit;
generating image-based inference information by inputting the text-based intermediate inference information, the text included in the question information (hereinafter referred to as “text question information”), and the image included in the question information (hereinafter referred to as “image question information”) to a multi-modal image generation model; and
generating text-based inference information by inputting the text-based intermediate inference information, the image-based inference information, and the text question information to a multi-modal text generation model.

2. The method of claim 1, wherein the generating of the formal languages by parsing the image and text of the question information, respectively, based on the pre-constructed problem solving template comprises:
generating a text embedding vector by performing text embedding on the text question information;
outputting results of search for the formal language from the problem solving template by inputting the text embedding vector to an encoder that constitutes a text-to-text generative model; and
generating a text format language by combining the results of the output with the text embedding vector and inputting results of the combination to a decoder that constitutes the text-to-text generative model.

3. The method of claim 1, wherein the generating of the formal languages by parsing the image and text of the question information, respectively, based on the pre-constructed problem solving template comprises:
generating an image embedding vector by performing image embedding on the image question information;
outputting results of search for the formal language from the problem solving template by inputting the image embedding vector to an encoder that constitutes an image-to-text generative model; and
generating an image format language by combining the results of the output with the image embedding vector and inputting results of the combination to a decoder that constitutes the image-to-text generative model.

4. The method of claim 1, wherein the generating of the image-based inference information comprises:
receiving the text-based intermediate inference information, the text question information, and the image question information;
performing text embedding on inference results for the question information and the text question information;
performing image embedding on the image question information;
inputting results of the text embedding and the image embedding to an encoder; and
generating the image-based inference information by inputting output results of the encoder to a decoder.

5. The method of claim 4, wherein the generating of the text-based inference information comprises:
receiving the text-based intermediate inference information, the image-based inference information, and the text question information;
performing text embedding on the text-based intermediate inference information and the text question information;
performing image embedding on the image-based inference information;
inputting results of the text embedding and the image embedding to an encoder; and
generating the text-based inference information by inputting output results of the encoder to a decoder.

6. A method for problem inference based on multi-modal generative artificial intelligence, the method being performed by a computer and comprising:
receiving question information comprising an image and text;
generating formal languages by parsing the image and text of the question information, respectively, based on a pre-constructed problem solving template;
generating text-based intermediate inference information for the question information by inputting the generated formal language to a formal language inference unit;
generating text-based inference information by inputting the text-based intermediate inference information, the text included in the question information (hereinafter referred to as “text question information”), and the image included in the question information (hereinafter referred to as “image question information”) to a multi-modal text generation model; and
generating image-based inference information by inputting the text-based inference information, the text-based intermediate inference information, and the image question information to a multi-modal image generation model.

7. The method of claim 6, wherein the generating of the formal languages by parsing the image and text of the question information, respectively, based on the pre-constructed problem solving template comprises:
generating a text embedding vector by performing text embedding on the text question information;
outputting results of search for the formal language from the problem solving template by inputting the text embedding vector to an encoder that constitutes a text-to-text generative model; and
generating a text format language by combining the results of the output with the text embedding vector and inputting results of the combination to a decoder that constitutes the text-to-text generative model.

8. The method of claim 6, wherein the generating of the formal languages by parsing the image and text of the question information, respectively, based on the pre-constructed problem solving template comprises:
generating an image embedding vector by performing image embedding on the image question information;
outputting results of search for the formal language from the problem solving template by inputting the image embedding vector to an encoder that constitutes an image-to-text generative model; and
generating an image format language by combining the results of the output with the image embedding vector and inputting results of the combination to a decoder that constitutes the image-to-text generative model.

9. The method of claim 6, wherein the generating of the text-based inference information comprises:
receiving the text-based intermediate inference information, the text question information, and the image question information;
performing text embedding on the text-based intermediate inference information and the text question information;
performing image embedding on the image question information;
inputting results of the text embedding and the image embedding to an encoder; and
generating the text-based inference information by inputting output results of the encoder to a decoder.

10. The method of claim 9, wherein the generating of the image-based inference information comprises:
receiving the text-based inference information, the text-based intermediate inference information, and the image question information;
performing text embedding on the text-based inference information and the text-based intermediate inference information;
performing image embedding on the image question information;
inputting results of the text embedding and the image embedding to an encoder; and
generating the image-based inference information by inputting output results of the encoder to a decoder.

11. A system for problem inference based on multi-modal generative artificial intelligence, the system comprising:
a communication module configured to receive question information comprising an image and text;
memory configured to store a pre-constructed problem solving template, a pre-trained formal language inference unit, a multi-modal image generation model, and a multi-modal text generation model and to store a program for generating text- or image-based inference information; and
a processor configured to generate formal languages by parsing the image and text of the question information, respectively based on the problem solving template, to generate text-based intermediate inference information for the question information by inputting the generated formal language to the formal language inference unit, to generate the image-based inference information by inputting the text-based intermediate inference information and the text included in the question information (hereinafter referred to as “text question information”) and the image included in the question information (hereinafter referred to as “image question information”) to the multi-modal image generation model, and to generate the text-based inference information by inputting the text-based intermediate inference information, the image-based inference information, and the text question information to the multi-modal text generation model, by executing the program stored in the memory.
